(19) United States
(12) Patent Application Publication
(10) Pub. No.: US 2006/0171649 A1
(43) Pub. Date: Aug. 3, 2006

(54) Wavelength monitoring and stabilization in wavelength division multiplexed systems

(75) Inventors: John Hsieh, Cupertino, CA (US); Suohai Mei, Cupertino, CA (US)

Correspondence Address: CARL T. REED;WORKMAN NYDEGGER, 1000 EAGLE GATE TOWER, 60 EAST SOUTH TEMPLE, SALT LAKE CITY, UT, 84111, US

(73) Assignee: Finisar Corporation

(21) Appl. No.: 11/047,151

(22) Filed: Jan. 31, 2005

(51) Int. Cl. G02B 6/10

(52) U.S. Cl. 385/130

(57) ABSTRACT

Systems and methods for monitoring wavelength in wavelength division multiplexed systems. A thin film filter is used with a pair of photodiodes to monitor the emitted wavelength of a laser. The thin film filter is configured to both reflect and transmit light equally at a particular wavelength of interest. The ratio between the optical power of the transmitted light and optical power of the reflected light can be used to detect wavelength drift. When the laser is drifting or is no longer emitting at the target wavelength, the wavelength locker can automatically adjust a temperature of the laser. Adjusting the temperature of the laser can change the emitted wavelength of the laser such that the emitted wavelength matches a target wavelength.

### CROSS REFERENCE TO RELATED APPLICATIONS

Not Applicable

### BACKGROUND OF THE INVENTION

1. The Field of the Invention

The present invention relates to systems and methods for stabilizing wavelengths emitted by lasers in optical transceivers. More particularly, the present invention relates to systems and methods for monitoring and stabilizing the wavelengths of lasers used in wavelength division multiplexed systems.

2. The Relevant Technology

Multiplexing is a technique that enables multiple signals to be transmitted on the same line at the same time. Wavelength division multiplexing (WDM) enables multiple optical signals to be transmitted over the same optical fiber. This is accomplished by having each signal have a different wavelength. On the transmission side, the various signals with different wavelengths are all injected into an optical fiber. At the receiving end of the transmission, the wavelengths are often separated. The advantage of WDM systems is that it effectively provides virtual fibers by making a single optical fiber carry multiple optical signals with different carrier wavelengths.

One of the problems that can occur in WDM systems is related to crosstalk. Crosstalk, in general, refers to how a particular signal is affected by other signals. In the context of WDM systems, crosstalk is a concern because multiple signals are being transmitted in a single optical fiber. When the separation between channels in a WDM system is relatively large, the effects of crosstalk and other problems are often minimal. However, crosstalk and other problems become more of a concern as the separation between signals or channels in a WDM system decreases.

For example, a dense DWM (DWDM) system may use carrier wavelengths where the separation between carrier wavelengths is less than a nanometer. One advantage of DWDM is that more carrier wavelengths can be used to increase the capacity of the DWDM system. At the same time, DWDM systems are more susceptible to problems such as crosstalk and the like.

Some of the problems, such as crosstalk and channel separation, in DWDM systems are related to the wavelengths emitted by the lasers in the optical transceivers. Most lasers experience wavelength drift, meaning that the emitted wavelength changes. Wavelength drift, by way of example, can degrade the performance of a DWDM transceiver, reduce channel separation with an adjacent channel, and create cross talk with adjacent channels.

One of the causes of wavelength drift is temperature. As temperature changes, the wavelength emitted by a laser typically drifts. Because of the adverse effects associated with wavelength drift, it is often useful to ensure that the wavelength emitted by a particular laser stays at or near a target wavelength.

Conventionally, optical transceivers use a TEC to set the laser diode to a specific constant temperature. Unfortunately, laser diodes have different thermal profiles at different ambient temperatures. In other words, the wavelength usually shifts with ambient temperature, while the TEC temperature is constant.

An alternative method is to used Etalon based wavelength lockers. While these types of wavelength lockers can provide accurate wavelength monitoring, they are expensive and highly temperature sensitive. In addition, the size of Etalon based prevents them from being integrated into standard size transceivers such as SFP transceivers, GBIC transceivers, XFP transceivers, etc., and are thus impractical for use in DWDM transceivers.

### BRIEF SUMMARY OF THE INVENTION

These and other limitations are overcome by the present invention, which relates to systems and methods for monitoring a laser. In one embodiment, a wavelength locker used to monitor the wavelength of the laser includes a pair of photodetectors and a thin film filter. The thin film filter is configured as a wavelength shifted thin film filter such that wavelengths of interest such as ITU wavelengths in wavelength division multiplexed systems are both transmitted and reflected substantially equally by the thin film filter.

The transmitted light is detected by a first photodiode which generates a corresponding current. The reflected light is detected by a second photodiode which generates a corresponding current. Using these currents, the optical power of the transmitted light and the optical power of the reflected light can be compared. When transmitted optical power is substantially equal to the reflected optical power, then the laser is emitting light at or near the target wavelength.

As the wavelength drifts, the ratio between the transmitted optical power and the reflected optical power begins to change as more current is generated by one of the photodiodes. The wavelength locker can use this change in the ratio to adjust the temperature of the laser, which also changes the emitted wavelength of the laser. The temperature is adjusted until the ratio between the transmitted optical power and the reflected optical power is at or near unity.

Advantageously, the sum of the reflected optical power and the transmitted optical power is substantially equal to the output optical power of the laser's back facet. Because the power at the back facet is related to the power of the front facet, the wavelength locker can also be used to monitor the output optical power of the laser. Finally, the wavelength can be calibrated such that a difference between the currents in the photodiodes can be used to determine the actual wavelength.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary network that implements dense wavelength division multiplexed signals;

FIG. 2 illustrates a perspective view of a transceiver with a wavelength locker in accordance with the present invention;

FIG. 3 illustrates one embodiment of a wavelength locker that uses a thin film filter; and

FIG. 4 illustrates an example of a wavelength response of a wavelength shifted thin film filter.

### DETAILED DESCRIPTION OF THE PREFERRED EMBODIMENTS

The present invention relates to systems and methods for monitoring the wavelengths emitted by a laser. Monitoring the wavelengths emitted by a laser includes adjusting the emitted wavelength as needed based on the emitted wavelength and a target wavelength. The ability to monitor wavelengths is useful in optical systems and in particular in wavelength division multiplexed (WDM) systems such as dense wavelength division multiplexing (DWDM) systems. As the wavelength begins to drift in a particular transceiver, it can have an adverse impact on adjacent wavelengths in the DWDM system.

Included in the systems and methods for monitoring the wavelengths emitted by a laser are a wavelength locker that uses a shifted thin film filter. The relationship between laser light transmitted and reflected by the thin film filter can be used to detect wavelength drift as well as compensate the laser for the experienced wavelength drift. For example, the information collected from using the thin film filter can be used to either increase or decrease the temperature of a laser, which has a corresponding impact on the emitted wavelength of the laser. Thus, using the relationship between the light transmitted and the light reflected by the thin film filter, the temperature of the laser can be adjusted to bring the laser back to a preferred or target wavelength.

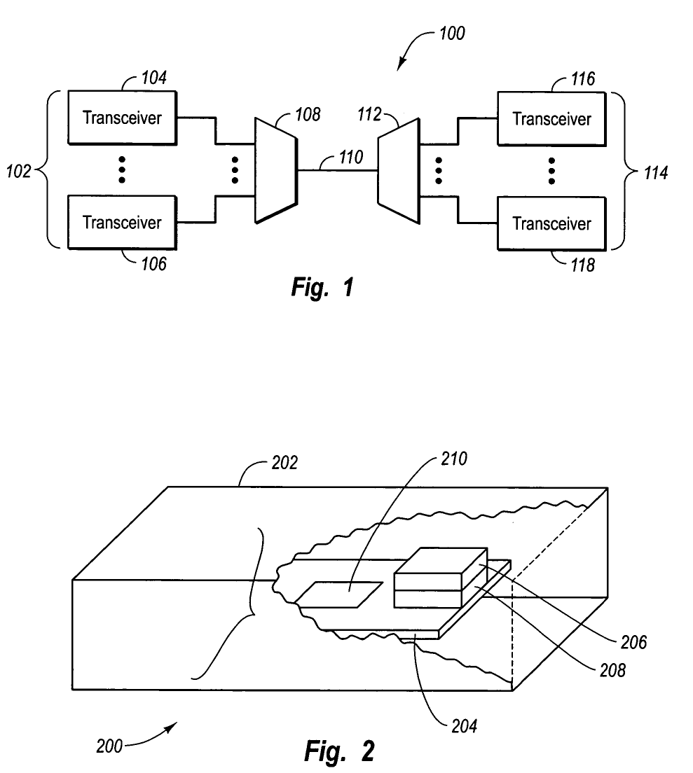

FIG. 1 illustrates an exemplary environment for implementing embodiments of the invention. The network 100 is an illustrative in nature and one of skill in the art can appreciate other network configurations for implementing embodiments of the invention with the benefit of this disclosure. The network 100 in FIG. 1 is configured for wavelength division multiplexing (WDM) including dense wavelength division multiplexing (DWDM). The transceivers 102 include lasers that generate signals or channels at different wavelengths. The signals generated by the transceivers 102 are multiplexed together by a multiplexor 108 and transmitted over an optical fiber 110. As previously stated, DWDM multiplexed signals enable the fiber 110 to carry multiple signals using a single optical link and can increase the overall data transmission capacity.

Next, the DWDM signals are demultiplexed by the demultiplexor 112, which directs the various wavelengths to the respective transceivers 114. In this example, each of the transceivers 114 includes a receiver that can detect the DWDM signals. One of skill in the art can appreciate that the transceivers 114 can also transmit DWDM signals to the transceivers 102.

FIG. 2 illustrates a perspective view of an exemplary transmitter optical subassembly (TOSA) 200 used in a transceiver. Inside the housing 202 is mounted a circuit board 204. The transceiver 200 includes a laser 206 whose temperature can be controlled or adjusted with a thermoelectric cooler (TEC) 208. The wavelength locker 210 is also mounted to the board 204 and is positioned to detect laser emissions through a back facet of the laser 206. The laser emissions detected by the wavelength locker 210 are analyzed and the temperature of the laser 206 is adjusted accordingly using the TEC 208 to ensure that the emitted wavelength of the laser 206 is at or near a target wavelength.

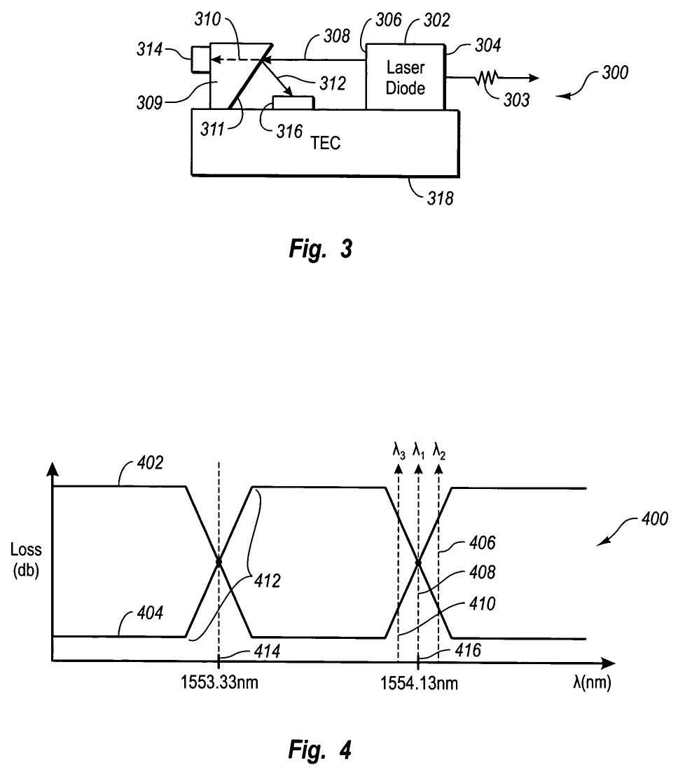

FIG. 3 illustrates an exemplary block diagram of the wavelength locker portion of a transceiver 300. In this example, the laser diode 304 is mounted on a TEC 318. The laser emits light 303 through a front facet at a certain wavelength. The light 303 may be used in a DWDM system. Light 308 exiting a back facet 306 of the laser 304 is used to monitor and/or adjust the wavelength of the light 303.

This example illustrates a thin film filter 309 with an angled surface 311. The thin film filter 309 typically includes a thin film formed on a substrate that is typically transparent to the laser light. The thin film itself can include multiple layers of varying thickness. In this embodiment, the thin film is designed such that wavelengths of interest are both transmitted and reflected equally. In one embodiment, the filter is shifted with respect to wavelengths of interest (DWDM wavelengths, for example) to achieve this behavior. The loss of the filter as a function of wavelength, which is manifested in the current generated at the photodetectors 314 and 316, changes as the emitted wavelength drifts from a target wavelength. This change enables the wavelength locker to dynamically adjust the emitted wavelength by changing the laser temperature as well as monitor optical power. This change can also be used to identify the actual wavelength with proper calibration.

In this example, the light 308 impinges the thin film filter 309. A portion 310 of the light 308 is transmitted by the thin film filter 309 and a portion 312 of the light 308 is reflected by the thin film filter 309. The portion 310 transmitted through the filter 309 is detected by a first photodiode 314. The portion 312 reflected by the thin film filter 309 is detected by a second photodiode 316. The photodiode 314 is positioned to receive the portion 310 and the photodiode 316 is positioned to receive the portion 312 of the light 308. The angled surface 311 is angled such that the portion 312 of the light 308 is reflected towards the photodiode 316.

One of skill in the art can appreciate other configurations and placements of the photodiode 314 and 316. Wherever placed, one of the photodiodes detects the portion of laser light transmitted by the thin film filter and the other photodiode detects the portion of laser light that is not transmitted or that is reflected by the thin film filter.

The example of FIG. 3 illustrates that the thin film filter 309, the photodiode 316 are also connected with the TEC 318. One of skill in the art can appreciate that the TEC may only be connected to the laser diode 302 in order to provide the necessary temperature adjustment. The other components of the wavelength locker in the transceiver 300 can be mounted on a different substrate.

FIG. 4 illustrates a wavelength versus loss characteristics of a wavelength shifted thin film filter. The line 402 represents wavelength reflected by the thin film filter and the line 404 represents wavelength transmitted by the thin film filter. In this example, the examples of preferred wavelengths of the DWDM system occur at wavelengths 414 and 416. Thus, the response of the thin film filter, such as the filter 309, is shifted with respect to the wavelengths of a DWDM or other WDM system. The thin film filter of the wavelength locker is typically configured to both reflect and transmit a particular wavelength substantially equally.

In this example, the line 402 also corresponds to light detected by the photodiode 316 while the line 404 corresponds to light detected by the photodetector 314. The photodetector 314 generates a current I₁ and the photodetector 316 generates a current I₂ in response to the detected light portions 310 and 312, respectively. When I₁=I₂, then the emitted wavelength of the laser is at the desired wavelength, which is the wavelength 416 or λ₁. When the wavelength shifts in the long wavelength direction (represented by λ₂), then I₁ decreases and I₂ increases. When the wavelength shifts in the short wavelength direction (represented by λ₃), then I₁ increases and I₂ decreases.

When I₁ is substantially equal to I₂, then the wavelength emitted by the laser is at the target wavelength of λ₁. In other words, when the ratio of the transmitted optical power determined from the first photodetector is substantially equal to the reflected optical power determined from the second photodetector, the laser is at the target wavelength. When the ratio of the transmitted optical power to the reflected optical power begins to increase or decrease, then the wavelength of the laser is no longer at the target wavelength λ₁. The ratio can thus be used to drive the TEC to change the temperature of the laser, which has an effect on the emitted wavelength of the laser. With proper calibration, I₁(λ)-I₂(λ) can be used to determine the actual wavelength of the laser.

With continued reference to FIG. 4, the slope 412 of the thin film filter can have an impact on the sensitivity of the wavelength locker. A steeper slope 412 can provide increased sensitivity to the wavelength locker and enable the emitted wavelength to be adjusted more quickly to account for wavelength drift. The steepness of the slope 412 is determined by the characteristics of the thin film filter. The steepness of the filter can be controlled by the structure of the thin film filter. The number of layers, and material composition, for example, can be controlled to set the steepness of the filter. Typically, embodiments of the invention use one thin film filter, although additional thin film filters are within the scope of the invention.

Embodiments of the invention can also be used to monitor the optical output power emitted from the front facet of the laser. For example, the transmitted optical power can be determined from I₁ and the reflected optical power can be determined from I₂. The sum of the transmitted optical power and the reflected optical power is substantially equal to the output optical power emitted from the back facet of the laser diode. Further, the optical power emitted from the back facet is usually related to the output optical power of the front facet of the laser. Thus, the transmitted optical power and the reflected optical power can be used to monitor the laser optical output power.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wavelength locker for monitoring an emitted wavelength of a laser in a transceiver, the wavelength locker comprising:
a thin film filter positioned to receive light emitted from a back facet of a laser, wherein the thin film filter transmits a first portion of the light and reflects second portion of the light;
a first photodetector that receives the first portion of the light and generates a first optical power in response thereto; and
a second photodetector that receives the second portion of the light and generates a second optical power in response thereto, wherein a ratio of the first optical power to the second optical power is used to monitor the emitted wavelength of the laser.

2. A wavelength locker as defined in claim 1, further comprising a thermoelectric cooler used to control a temperature of the laser.

3. A wavelength locker as defined in claim 2, wherein the ratio is used to control the thermoelectric cooler to change the emitted wavelength of the laser to a target wavelength by changing a temperature of the laser.

4. A wavelength locker as defined in claim 1, wherein the first photodetector is coupled to a substrate of the thin film filter to receive the first portion of the light that is transmitted through the thin film filter.

5. A wavelength locker as defined in claim 1, wherein the thin film filter has an angled surface to reflect the second portion of the light to the second photodetector.

6. A wavelength locker as defined in claim 1, wherein the thin film filter has a wavelength response that is shifted from a target wavelength of the laser.

7. In a system that transmits dense wavelength division multiplexed signals, a wavelength locker for adjusting an emitted wavelength of a laser to a target wavelength, the wavelength locker comprising:
a thin film filter mounted on a substrate to receive laser light emitted from a back facet of a laser, the thin film filter having a wavelength response that is shifted with respect to a target wavelength, wherein a first portion of the laser light transmitted by the thin film filter changes as the emitted wavelength drifts from the target wavelength;
a first photodiode positioned to receive the first portion of the laser light transmitted by the thin film filter and detect a first optical power;
a second photodiode positioned to receive a second portion of the laser light reflected by the thin film filter and detect a second optical power; and
a thermoelectric cooler that changes a temperature based on a ratio of the first optical power to the second optical power.

8. A wavelength locker as defined in claim 7, wherein the thin film filter has an angled surface that receives the laser light emitted from the back facet of the laser, wherein the angled surface reflects the second portion of the laser light towards the second photodiode.

9. A wavelength locker as defined in claim 7, the thin film filter further comprising a plurality of layers configured to provide the wavelength response.

10. A wavelength locker as defined in claim 7, the wavelength response of the thin film filter having a steepness that determines a sensitivity of the wavelength locker to changes in the emitted wavelength of the laser.

11. A wavelength locker as defined in claim 10, wherein the emitted wavelength of the laser approaches the target wavelength when the ratio of the first optical power to the second optical power is approaches unity.

12. A wavelength locker as defined in claim 7, wherein a power of laser light emitted from a front facet of the laser is monitored by summing the first optical power and the second optical power.

13. A method for adjusting an emitted wavelength of a laser such that the emitted wavelength is substantially equal to a target wavelength, the method comprising:
receiving a first portion of laser light at a first photodetector, wherein the first portion of laser light is transmitted through a thin film filter having a response that is offset with respect to a target wavelength of the laser;
receiving a second portion of laser light at a second photodetector, wherein the second portion of laser light is reflected by the thin film filter;
determining a ratio of a first optical power from the first photodetector to a second optical power from the second photodetector; and
adjusting a temperature of the laser based on the ratio such that an emitted wavelength of the laser is substantially maintained at the target wavelength.

14. A method as defined in claim 13, wherein the thin film filter comprises an angled surface, further comprises mounting the thin film filter in a path of the first portion of the laser light and the second portion of laser light.

15. A method as defined in claim 13, further comprising positioning the thin film filter to reflect the second portion of laser light.

16. A method as defined in claim 13, further comprising summing the first optical power and the second optical power to determine an optical power of the laser.

17. A method as defined in claim 13, further comprising calibrating the laser in order to determine an actual emitted wavelength based on the ratio.

18. A method as defined in claim 13, further comprising selecting a sensitivity of the wavelength locker by setting a slope of the response of the thin film filter.

19. A method as defined in claim 13, further comprising determining an actual wavelength of the laser based on a difference between the first optical power and the second optical power.

20. A method as defined in claim 19, further comprising determining the actual wavelength based on a first current generated in response to the first portion of laser light and a second current generated in response to the second portion of laser light.
